(19) United States
(12) Patent Application Publication
(10) Pub. No.: US 2022/0415349 A1
(43) Pub. Date: Dec. 29, 2022

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventors: Toru WATANABE, Kawasaki Kanagawa (JP); Masami YAMANE, Kawasaki Kanagawa (JP)

(21) Appl. No.: 17/589,028

(22) Filed: Jan. 31, 2022

(30) Foreign Application Priority Data
Jun. 29, 2021 (JP) 2021-107222

(51) Int. Cl. G11B 5/60; G11B 5/54

(52) U.S. Cl. CPC G11B 5/6005; G11B 5/54; G11B 2220/2516

(57) ABSTRACT

According to one embodiment, a magnetic disk device includes a rotatable magnetic disk and a magnetic head including a recording head portion that records data on the magnetic disk. The recording head portion includes a main magnetic pole that applies a recording magnetic field to the magnetic disk, a first yoke provided on a first side of the main magnetic pole and a second yoke provided on a second side of the main magnetic pole, which is opposite to the first side. The magnetic head includes a first heater provided to oppose a side of the first yoke, opposite to the main magnetic pole and a second heater provided to oppose a side of the second yoke, opposite from the main magnetic pole.

### CROSS-REFERENCE TO RELATED APPLICATIONS

This application is based upon and claims the benefit of priority from Japanese Patent Application No. 2021-107222, filed Jun. 29, 2021, the entire contents of which are incorporated herein by reference.

### FIELD

Embodiments described herein relate generally to a magnetic disk device.

### BACKGROUND

As a magnetic recording and reproducing device, for example, a magnetic disk device comprises a rotatable disk-shaped recording medium, a magnetic head for recording/reproducing data on a magnetic recording layer of the recording medium and a head actuator that positions the magnetic head at a desired radial position on the recording medium. The magnetic head includes a slider, a reproducing element and a recording element provided on the slider. In order to improve the recording density, a magnetic head having an assist function, for example, a heater, have been proposed. Here, by heating the magnetic head with the heater, the reproducing element and/or recording element are expanded to the recording medium side, so as to control the distance between the reproducing and/or recording element and the surface of the recording medium.

However, it takes a certain amount of time until the temperature of the magnetic head, especially the recording element section and the entire head, to saturate. For example, a certain amount of time is required from the time when the heater is started to be energized for the recording element to expand and protrude to the desired position. On the other hand, it is required for the magnetic disk drives to record data at high speed by shortening the time from the start to the end of writing. In order to shorten the time to start writing, it is necessary to shorten the above-described protruding time. Therefore, in order to achieve high-speed processing in a magnetic disk device, the protruding time needs to be shortened.

### BRIEF DESCRIPTION OF THE DRAWINGS

FIG. 1 is a block diagram schematically showing a magnetic disk device according to a first embodiment.

FIG. 2 is a cross-sectional view showing a head portion of a magnetic head in a flying state and a magnetic disk in the magnetic disk device.

FIG. 3 is a diagram showing an example of the shape of a heater in the magnetic head.

FIG. 4 is a diagram showing an example of connection between, the heater and the heater voltage supply circuit in the magnetic head.

FIG. 5 is a diagram showing another example of connection between the heater and the heater voltage supply circuit in the magnetic head.

FIG. 6 is a diagram showing still another example of connection between the heater and the heater voltage supply circuit in the magnetic head.

FIG. 7 is a diagram showing an example of protrusion of the magnetic head portion.

FIG. 8 is a cross-sectional view of a head portion of a magnetic head according to a comparative example.

FIG. 9 is a diagram showing an example of temperature distribution when heating the magnetic head according to the comparative example.

FIG. 10 is a diagram showing an example of temperature distribution when heating the magnetic head according to the first embodiment.

FIG. 11 is a diagram showing an example of a comparison between the magnetic head of the first embodiment and the magnetic head of the comparison example in term of the relationship between the time of heating and the average temperature.

FIG. 12 is a diagram showing a comparison between the magnetic head of the first embodiment and the magnetic head of the comparison example in an example of the relationship between the time of heating and the gap.

FIG. 13 is a cross-sectional view of a head portion of a magnetic head in a flying state and a magnetic disk in a magnetic disk device according to the second embodiment.

FIG. 14 is a diagram showing an example of the shape of a heater of the magnetic head in the second embodiment.

FIG. 15 is a diagram showing an example of the shape of the heater of the magnetic head in, the second embodiment.

### DETAILED DESCRIPTION

Various embodiments will be described hereinafter with reference to the accompanying drawings. In general, according to one embodiment, a magnetic disk device comprises a rotatable magnetic disk and a magnetic head including a recording head portion that records data on the magnetic disk. The recording head portion comprises a main magnetic pole that applies a recording magnetic field to the magnetic disk, a first yoke provided on a first side of the main magnetic pole and a second yoke provided on a second side of the main magnetic pole, which is opposite to the first side. The magnetic head includes a first heater provided to oppose a side of the first yoke, opposite to the main magnetic pole and a second heater provided to oppose a side of the second yoke, opposite from the main magnetic pole.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

### First Embodiment

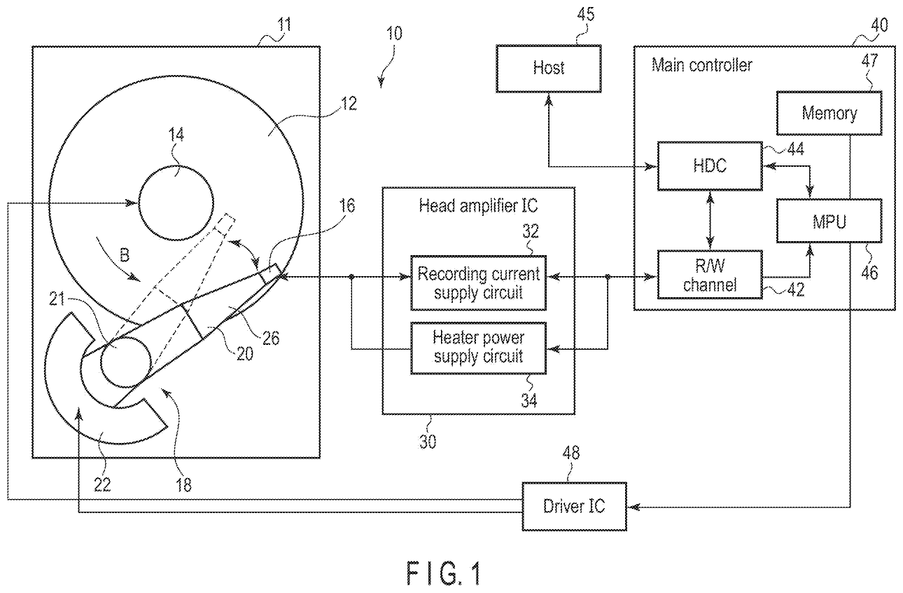

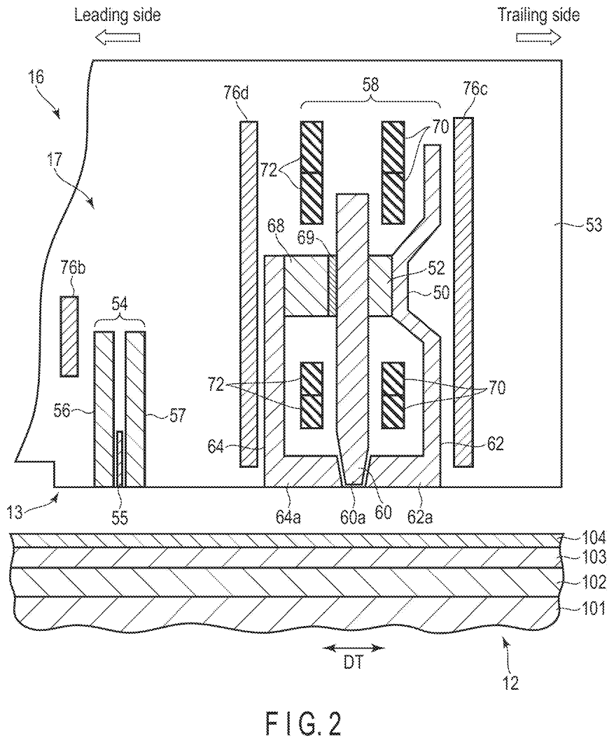

As an example of the magnetic disk devices, a hard disk drive (HDD) according to the first embodiment will be described in detail. FIG. 1 is a block diagram schematically showing the HDD of the first embodiment, and FIG. 2 is a cross-sectional view showing a head portion of a magnetic head in the flying state and a magnetic disk.

As shown in FIG. 1, the HDD 10 comprises a rectangular-shaped housing 11, magnetic disks 12 as a recording medium installed in the housing 11, a spindle motor 14 that supports and rotates the magnetic disks 12, and magnetic heads 16 that each record (writes) and reproduce (reads) data with respect to the respective magnetic disk 12. The HDD 10 comprises a head actuator 18 that moves and positions the respective magnetic head 16 on an arbitrary track on the respective magnetic disk 12. The head actuator 18 includes a carriage assembly 20 that supports the magnetic heads 16 movably and a voice coil motor (VON) 22 that pivots the carriage assembly 20.

The HDD 10 comprises a head amplifier IC 30 that drives the magnetic heads 16, a main controller 40 and a driver IC 48. The head amplifier IC 30 is, for example, provided on the carriage assembly 20 and is electrically connected to the magnetic heads 16. The head amplifier IC 30 comprises a recording current supply circuit 32 that supplies a recording current to the recording coils of the magnetic heads 16, a heater voltage supply circuit 34 that supplies drive power to a thermal actuator (to be referred to as “heater” hereinafter) of the magnetic heads 16, which will be described later and an amplifier (not shown) that amplifies the signal read by the magnetic heads 16, and the like.

The main controller 40 and the driver IC 48 are, for example, installed on a control circuit board (not shown) provided on a rear surface side of the housing 11. The main controller 40 comprises an R/W channel 42, a hard disk controller (HDC) 44, a microprocessor (MPU) 46, a memory 47 and the like. The main controller 40 is electrically connected to the magnetic head 16 via the head amplifier IC 30. The main controller 40 is electrically connected to the VCM 22 and the spindle motor 14 via the driver IC 48. Note that the HOC 44 is connectable to a host computer 45.

In the memory 47 of the main controller 40, a heater power setting table (not shown) and the like, are stored. In the main controller 40, for example, the MPU 46 adjusts the power supplied to the heater based on the heater power setting table.

As shown in FIGS. 1 and 2, the magnetic disks 12 are each configured as a perpendicular magnetic recording medium. The magnetic disks 12 each include a substrate 101 formed, for example, into a discoidal shape with a diameter of 96 mm (about 3.5 inches) and made of a non-magnetic material. On each of the surfaces of the substrate 101, a soft magnetic layer 102 made of a material that exhibits soft magnetic properties as a base layer, a perpendicular magnetic recording layer 103 having magnetic anisotropy in the perpendicular direction to the surface of the magnetic disk 12 as an upper layer, and a protective film 10 4 are stacked in order. The magnetic disks 12 are fit to the hub of the spindle motor 14 so as to be coaxial with each other. The magnetic disks 12 are rotated in the direction indicated by arrow B at a predetermined speed by the spindle motor 14.

As shown in FIG. 1, the carriage assembly 20 includes a bearing portion 21 rotatably supported by the housing 11, and a plurality of suspensions 26 extending from the bearing section 21. The magnetic heads 16 are supported on extending ends of the respective suspensions 26. The magnetic heads 16 are electrically connected to the head amplifier IC 30 via respective wiring members (flexures) provided in the carriage assembly 20.

The magnetic heads 16 each comprise a substantially rectangular disk-facing surface (air bearing surface (ABS)) 13 that opposes the surface of the respective magnetic disk 12. The Magnetic head 16 is maintained in a state where it flies a predetermined amount above the surface of the respective magnetic disk 12 by air flow generated between the disk surface and the ABS 13 by the rotation of the magnetic disk 12. The direction of the air flow coincides with the rotational direction B of the magnetic disk 12. As the magnetic disk 12 rotates, the magnetic head 16 travels in a direction opposite to the disk rotation direction B with respect to the magnetic disk 12.

As shown in FIG. 2, the head portion 17 includes a reproduction head (reproduction head portion) 54 and a recording head (recording head portion) 54, formed by a thin-film process on a trailing edge located on the outflow side of the air flow, and is formed as a separate magnetic head. The reproduction head 54 and the recording head 58 are covered by a non-magnetic protective insulating film 53, except for the portion exposed to the ABS 13. The protective insulating film 53 constitutes an outline of the head portion 17. Further, the head portion 17 includes a heater (first heater) 76c and another heater (second heater) 76d, which control the protrusion amount of the recording head 58, and another heater (third heater) 76b, which controls the protrusion amount of the reproduction head 54. The heaters 76c and 76d are embedded in the protective insulating film 53 and are located in the vicinity of the recording head 58. The heater 76b is embedded in the protective insulating film 53 and is located in the vicinity of the reproduction head 54. The detailed configuration of the heaters will be described later.

The longitudinal direction of the recording track formed on the perpendicular magnetic recording layer 103 of the magnetic disk 12 is defined as a down-track direction DT, and the width direction of the recording track orthogonal to the longitudinal direction is defined as a cross-track, direction.

The reproduction head 54 includes a magnetoresistive element 55 and a first magnetic shield film 56 and a second magnetic shield film 57 disposed respectively on a leading side and a trailing side of the magnetoresistive effect element 55 in the down track direction DT so as to interpose the magnetoresistive effect element 55 therebetween. The magnetoresistive element 55, the first and second magnetic shielding films 56 and 57 are extend substantially perpendicularly to the ABS 13.

The recording head 58 is provided on a trailing side (a first side) of the slider 15 with respect to the reproduction head 54. The opposite side of the trailing side is a leading side (a second side). The recording head 58 includes a main magnetic pole 60 that generates a recording magnetic field in the perpendicular direction to the surface of the magnetic disk 12, a trailing shield (a first yoke) 6 provided on the trailing side of the main magnetic pole 60 and opposing the main magnetic pole 60 with a wright gap. 62, a leading shield (a second yoke) 64 opposing the leading side of the main magnetic pole 60, and a pair of side shields (not shown) formed to be integrated with the leading shield and provided on respective sides both sides of the main magnetic pole 60 along the cross track direction. The main magnetic pole 60 and the trailing shield 62 constitute a first magnetic core which forms a magnetic path, and the main magnetic pole 60 and the leading shield 64 constitutes a second magnetic core that forms a magnetic path. The recording head 58 includes a first recording coil 70 wound on the first magnetic core and a second recording coil 70 wound on the second magnetic core.

The main magnetic pole 60 is formed from a soft magnetic material having high magnetic permeability and high saturation flux density, and extends substantially perpendicular to the ABS 13. A distal end portion 60a of the main magnetic pole 60 on the ABS 13 side is tapered down toward the ABS 13 and formed into a columnar shape having a width less relative to those of other parts.

The trailing shield 62 is formed of a soft magnetic material and is provided to efficiently close the magnetic path via the soft magnetic layer 102 of the magnetic disk 12 directly under the main magnetic pole 60. The trailing shield 62 is formed into a substantially L-shape, and a distal end portion thereof 62a is formed into a slender rectangular shape.

The trailing shield 62 includes a first connection portion 50 connected to the main magnetic pole 60. The first connection portion 50 is magnetically connected to an upper portion of the main magnetic pole 60, that is, a portion of the main magnetic pole 60, which is away from the ABS 13, via a non-conductive material 52. The first recording coil 70 is wound around, for example, the first connection portion 50 in the first magnetic core. When writing a signal to the magnetic disk 12, a recording current is applied to the first recording coil 70, and thus the first recording coil 70 excites the main magnetic pole 60 to make magnetic flux flow to the main magnetic pole 60.

The leading shield 64, formed of a soft magnetic material, is provided on the leading side of the main magnetic pole 60, to oppose the main magnetic pole 60. The leading shield 64 is formed into substantially an L-shape, and the leading portion 64a on the ABS 13 side formed into a slender rectangular shape.

Further, the leading shield 64 includes a second connection portion 68 bonded to the main magnetic pole 60 at a position separated from the ABS 13. The second connection 68 is formed, for example, of a soft magnetic material, and is magnetically connected to the upper portion of the main magnetic pole 60, that is, the portion of the main magnetic pole 60, which is away from the ABS 13, via the non-conductive material 69. Thus, the second connection 68 forms a magnetic circuit together with the main magnetic pole 60 and the leading shield 64. The second recording coil 72 of the recording head 58 is, for example, wound around the second connection 68. The second recording coil 72 of the recording head 58, for example, is arranged to be wound around the second connection 63 so as to apply a magnetic field to the magnetic circuit.

The configurations of the heaters will now described.

As shown in FIG. 2, the heater 76c and the heater 76d are arranged so as to interpose the recording head 58 therebetween. In more detail, the heater 76c, the trailing shield 62, the main magnetic pole 60, the leading shield 64 and the heater 76d are arranged in this order from the trailing side. In other words, the recording head 58 includes a trailing shield 62 provided on the trailing side of the main magnetic pole 60 and a leading shield 64 provided on the leading side opposite to the trailing side. The magnetic head 16 includes the heater 76c provided on a side of the trailing shield 62, which is opposite to the main magnetic pole 60, and the heater 76d provided on a side of the leading shield 64, which is opposite to the main magnetic pole 60. A lower end of each of the heaters 76c and 76d extends to the vicinity of the ABS 13 without being exposed to the ABS 13 and an upper end of each of the heaters 76c and 76d is placed at a height that substantially coincides with the upper end of the recording head 58.

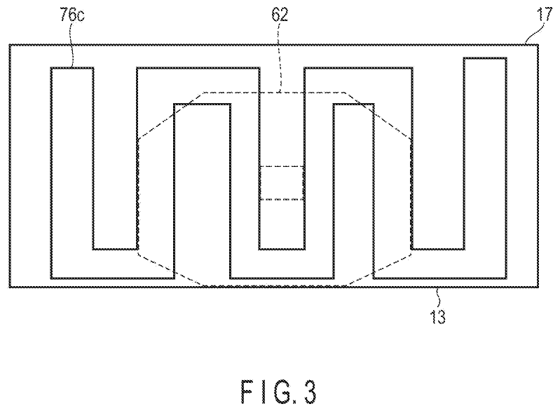

FIG. 3 is a side view showing an example of the shape of the heater 76c.

As shown in FIG. 3, the heater (first heater) 76c comprises a plurality of such configurations in each of which one right-angle and U-shaped end thereof is connected to an adjacent right-angle and U-shaped end. In other words, it is shaped such that rectangular notches are provided at predetermined intervals in the longitudinal direction of the rectangular material. The notches each have a rectangular shape elongated in the short side direction of the material, and the notches are alternately provided.

With this structure, the heater 76c includes a plurality of vertical portion each extending perpendicular to the ABS 13, and the vertical portions are arranged in the track width direction so as to be spaced apart from each other. The vertical portions located at both ends in the track width direction extend upward beyond the upper end of the trailing shield 62, and the upper ends of the vertical portions are substantially alignment with the upper end of the recording head 58. Those vertical portions in the middle section along the track width direction are located to oppose the trailing shield 62, extend upward beyond the upper end of the trailing shield 62, and the upper ends of the vertical portions are substantially alignment with the upper end of the recording head 58. The lower side of the heater 76c is not exposed to the ABS 13, but extends to the vicinity of the ABS 13.

Note that the heater (second heater) 76d has a shape similar to that of the heater 76c.

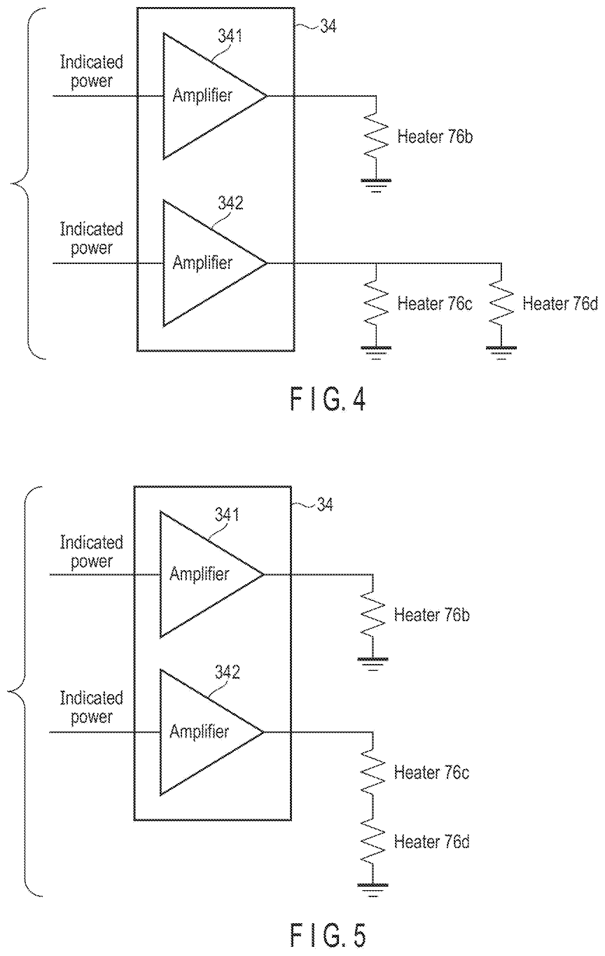

Next, an example of connection between the heater 76b, heater 76c and heater 76d, and the heater voltage supply circuit 34 of the head amplifier IC 30 will be described with reference to FIGS. 4 to 6.

In the example of the connection shown in FIG. 4, the heater voltage supply circuit 34 includes an amplifier 341 and an amplifier 342, and, the amplifier 341 is connected to the heater 76b, whereas the amplifier 342 is connected in parallel with the heater 76c and the heater 76d. To the amplifier 341 and the amplifier 342, indicated power directed by the MPU 46 are input, respectively. The power is supplied from the amplifier 341 to the heater 76b for the heater 76h to heat. The amplifier 342 supplies the power to the heater 76c and the heater 76d form these to heat.

In the example of the connection shown in FIG. 5, the heater 76c and the heater 76d are connected in series to the amplifier 342. When the heaters 76c and 76d are connected in series, the recording head 542 can be efficiently heated.

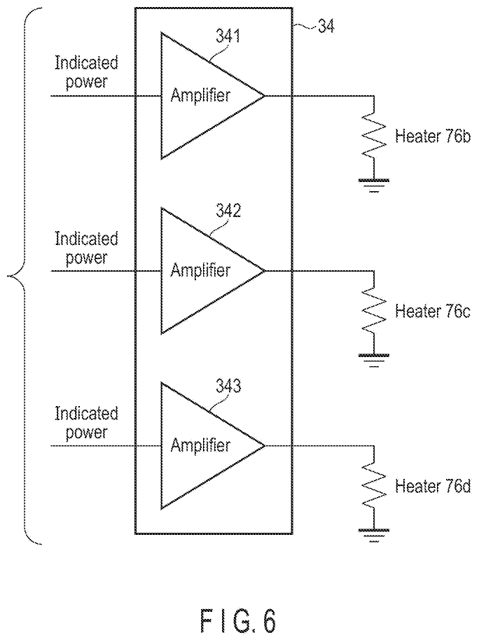

In the example of the connection shown in FIG. 6, the heater voltage supply circuit 34 includes the amplifier 341, the amplifier 342 and the amplifier 343, and the amplifiers 341, 342 and 343 are connected to the heater 76b, the heater 76c and the heater 76d, respectively.

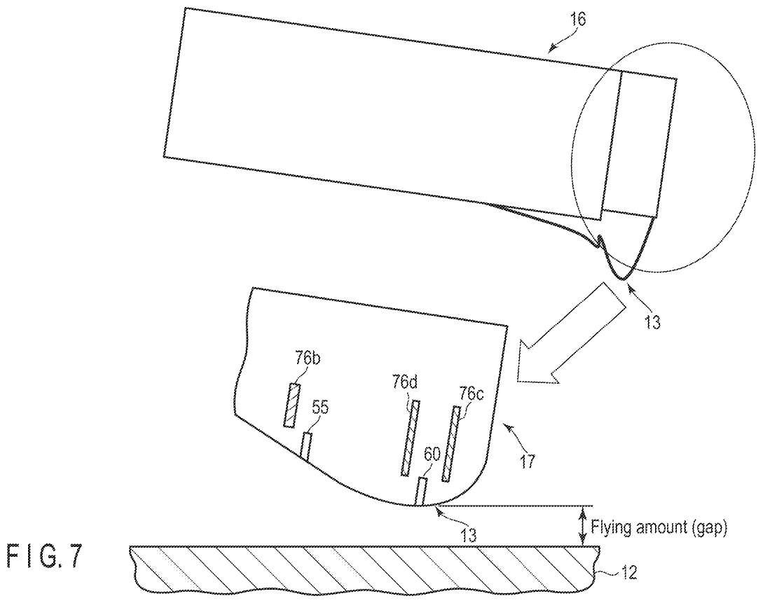

FIG. 7 is a diagram showing an example of protrusion of the head portion.

When recording data on a magnetic disk, the indicated voltage is applied to the heaters 76c and 76d based on the instructions of the MPU 46, and the recording head 58 is thermally expanded by the heat of the heaters 76c and 76d. In more detail, by applying voltage to the heaters 76c and 76d, the temperatures of the trailing shield 62, the leading shield 64, the first recording coil 70 and the second recording coil 72 are increased, to cause thermal expansion. Thus, the ABS 13 of the head portion 17 also expands toward the surface of the magnetic disk 12, and thus the flying amount with respect to the surface of the magnetic disk, that is, the gap between the ABS 13 of the head 17 and the surface of the magnetic disk 12 can be adjusted.

The head portion of the magnetic head according to a comparative example will now be described.

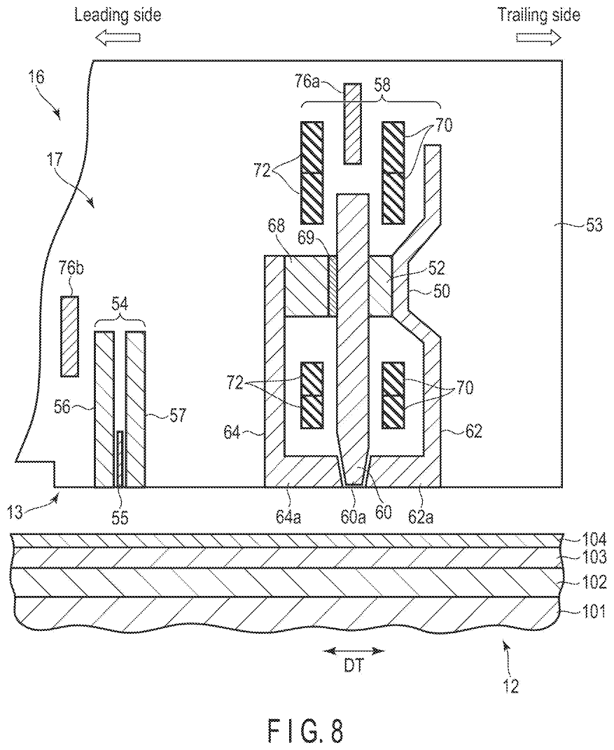

FIG. 8 is a cross-sectional view of a head portion of a magnetic head according to the comparative example. As shown in the figure, in the head portion 17 according to the comparative example, only a single heater 76a is provided as a heater to adjust the amount of protrusion of the recording head 58. The heater 76a is provided, for example, between the recording coils 70 and 72 and above the main magnetic pole 6.

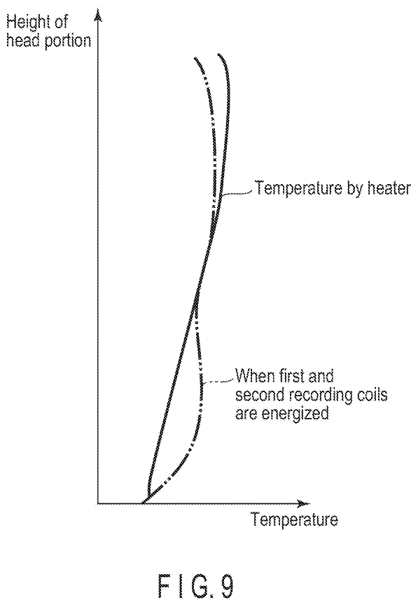

FIG. 9 is a diagram showing an example of the temperature distribution of the head portion when the heater 76a is heated in the magnetic head of the comparative example. In the figure, the horizontal axis indicates the temperature, and the vertical axis indicates the height of the head portion 17.

As shown in FIG. 9, the temperature rises in the vicinity where the heater 76a is located, but the heater 76a is located above the trailing shield 62, the leading shield 64, the first recording coil 70 and the second recording coil 72, and therefore the heat transfer of the heater 76a is weakened. After the voltage is applied to the heater 76a, when the first recording coil 70 and the second recording coil 72 are energized, the first recording coil 70 and the second recording coil 72 are heated, and therefore the temperature of the area where the first recording coil 70 and the second recording coil 72 are located increases. Thus, it can be understood that it takes time until the temperature becomes sufficiently high to form an appropriate gap.

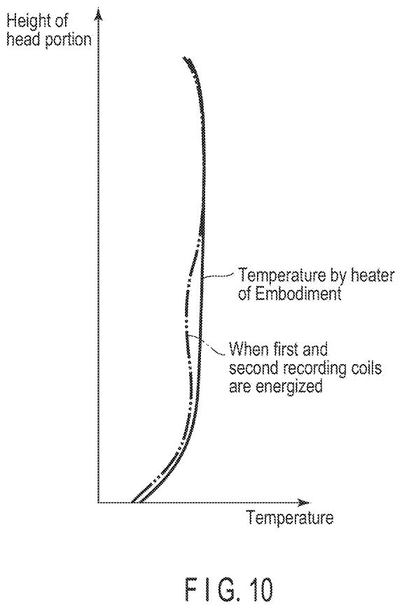

FIG. 10 is a diagram showing an example of the temperature distribution during heating of the magnetic head according to the first embodiment. In the figure, the horizontal axis indicates the temperature and the vertical axis indicates the height of the head portion 17.

As shown in FIG. 10, in the magnetic head of the first embodiment, the entire recording head 58 is heated by the heater 76c and the heater 76d.

Therefore, as compared to the temperature distribution of the comparative example shown in FIG. 9, it can be understood that the heat transfer of the heaters 76c and 76d is promoted, and the entire recording head 58 is heated. When the first recording coil 70 and the second recording coil 72 are energized, the first recording coil 70 and the second recording coil 72 are heated, but as compared to the temperature distribution in FIG. 9, it can be understood that the change in temperature is less.

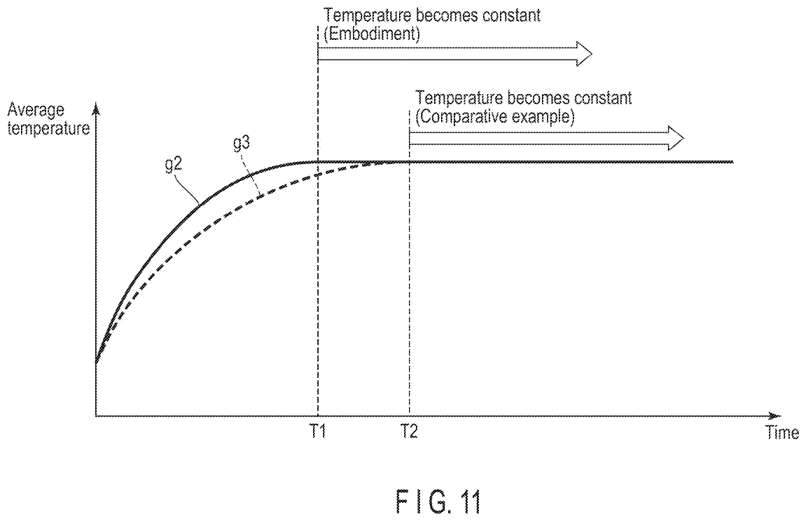

FIG. 11 is a diagram showing an example of comparison between the magnetic head of the first embodiment and the magnetic head of the comparison example in terms of the relationship between the time of heating and the average temperature. Here, the average temperature is the average of the temperatures of the main magnetic poles 60, the trailing shield 62 and the leading shield 64. A characteristic line g2 indicated by a solid line illustrates the characteristics of the magnetic head of the embodiment, and a characteristic line g3 indicated by a dashed line illustrates the characteristics of the magnetic head of the comparative example.

As shown in FIG. 11, the average temperature of the characteristic line g2 stabilizes earlier than that of the characteristic line g3. The time period from when the heaters are energized to the point when the temperature of the recording head 58 stabilizes is a time T1 in this embodiment, whereas in the comparative example, it is a time T2 (>T1). Since the recording of data is carried after the temperature of the recording head 58 stabilizes, it can be understood that the magnetic head of this embodiment can start data recording earlier than the magnetic head of the comparative example.

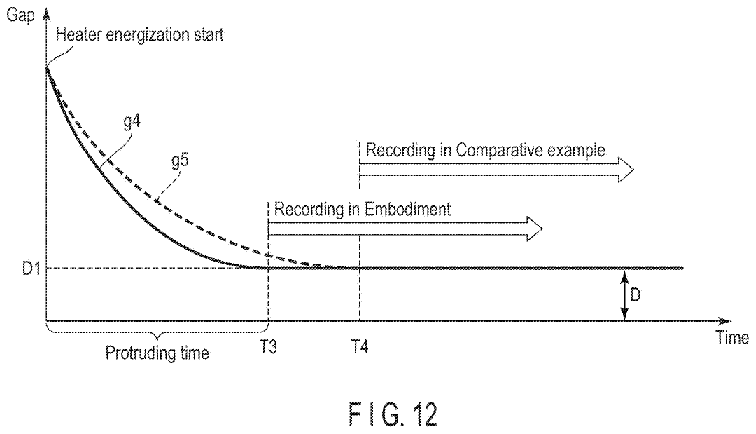

FIG. 12 is a diagram showing an example of a comparison between the magnetic head of the first embodiment and the magnetic head of the comparison example in terms of the relationship between the time of heating and the gap. Here, a gap D is the gap between the ABS 13 of the head portion 17 and the surface of the magnetic disk 12 (the flying amount). A characteristic line g4 indicated by a solid line illustrates the characteristics of the magnetic head of the embodiment, and a characteristic line g5 indicated by a dashed line illustrates the characteristics of the magnetic head of the comparative example.

As indicated by the characteristic line g4 in FIG. 12, when the heaters 76c and 76d are started to be energized, the head portion 17 gradually expands to reduce the gap D between the ABS 13 of the head portion 17 and the surface of the magnetic disk 12. Here, assuming that the gap D1 is a suitable distance for recording, the time until the gap becomes D1 is a time required for protruding the ABS 13, which is a protruding time T3.

As shown in the characteristic lines g4 and g5, the protruding time at which the gap D1 stabilizes is T3 for the magnetic head of this embodiment, whereas it is T4 (>T3) for the magnetic head of the comparative example, That is, it can be understood that the magnetic head of this embodiment reaches the gap D1 faster than the magnetic head of the comparative example. Since data recording is carried out after the gap is stabilized, the magnetic head of this embodiment is able to record data faster than the magnetic head of the comparative example.

According to the HDD 10 of the first embodiment, which is configured as described above, the recording head 5 can be efficiently heated by the heaters 76c and 76d located in the vicinity of the recording head 58. With this structure, in the HDD 10, the time required for the magnetic head to protrude can be shortened, making it possible to start recording earlier. Thus, the performance of the data recording process of the HDD 10 can be improved.

Next, the magnetic head of an HDD of another embodiment will be described. In this embodiment, which will be provided below, the same parts as those in the first embodiment described above are denoted by the same reference symbols as those of the first embodiment, and the detailed description thereof may be omitted or simplified.

### Second Embodiment

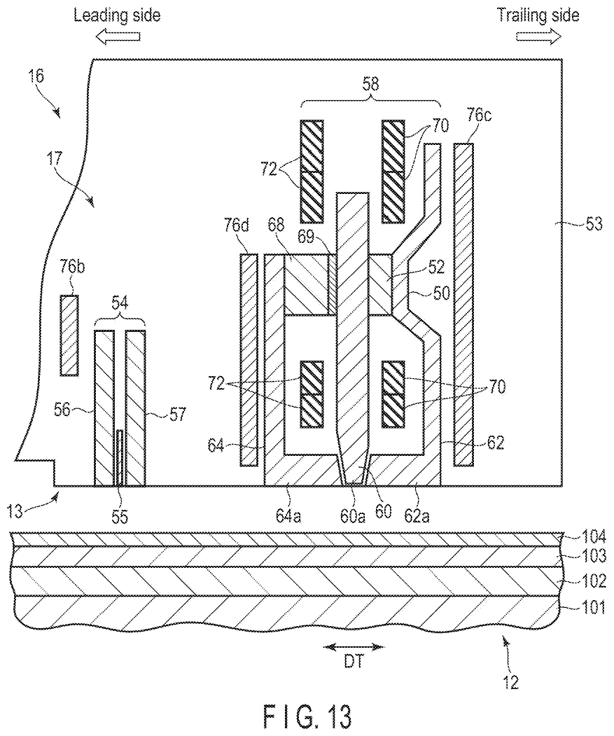

FIG. 13 is a cross-sectional view of a head portion of a magnetic head of an HDD and a magnetic disk in the second embodiment. The second embodiment is different from the first embodiment in the structure of the heaters. The structure of the HDD other than the heaters is the same as that of the HDD of the first embodiment. Therefore, the structure of the heaters will be explained in detail.

As shown in FIG. 13, a heater (first heater) 76c and another heater (second heaters) 76d are provided on respective sides of the recording head 58 while interposing the recording head 58 from both sides. The heaters 76c and 76d are each shortened in the vertical direction shown in the figure (the direction perpendicular to the ABS 13). Specifically, the lower end of the heater 76c extends to the vicinity of the ABS 13, and the upper end thereof is located at the same height as that of the upper end of the trailing shield 62. As in the case of the heater 76c, the lower end of the heater 76d is not exposed to the ABS 13, but extends to the vicinity of the ABS 13, and the upper end thereof is located at the same height as that of the upper end of the leading shield 64.

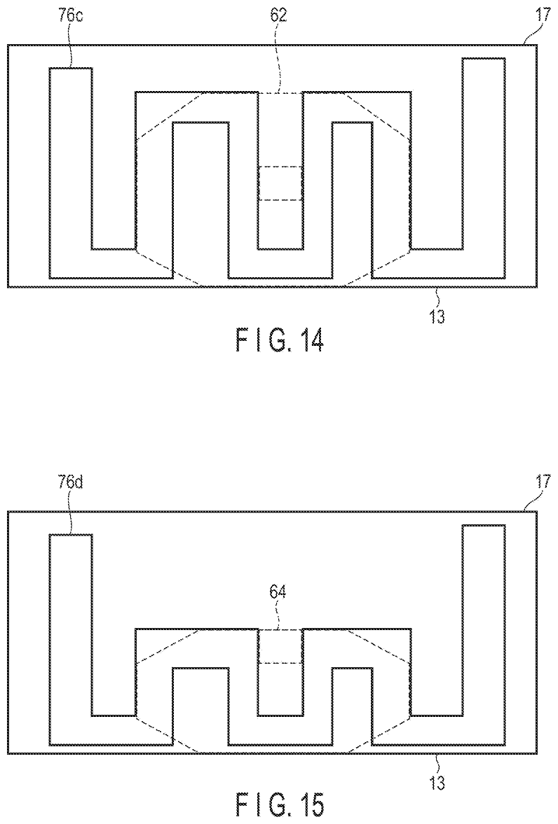

FIG. 14 is a side view showing an example of the shape of the heater 76c, and FIG. 15 is a side view showing an example of the shape of the heater 76d.

As shown in FIG. 14, the heater (first heater) 76c includes a plurality of vertical portions each extending perpendicular to the ABS 13, and arranged along the track width direction. The vertical portions located at both ends along the track width direction extend upward beyond the upper end of the trailing shield 62, while those vertical portions located in the middle along the track width direction are located to oppose the trailing shield 62 and at the same height as that of the trailing shield 62.

As shown in FIG. 15, the heater (second heater) 76d includes a plurality of vertical portions each extending perpendicular to the ABS 13, and arranged along the track width direction. The vertical portions located at both ends along the track width direction extend upward beyond the upper end of the leading shield 64, while those vertical portions located in the middle along the track width direction are located to oppose the leading shield 64 and at the same height as that of the leading shield 64.

As described above, the heaters 76c and heater 76d may be configured according to the sizes of the trailing shield 62 and the leading shield 64. With the above-described configuration, the recording head 58 can be thermally expanded more efficiently.

In the second embodiment as well, advantageous effect similar to those of the first embodiment described above can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The recording head of the magnetic head of each of the embodiments can be applied to a type which does not comprise a leading shield and/or side shields. The material, shape, size, etc., of the elements which constitute the head portion of the magnetic head can be changed as needed. In the magnetic disk device, the number of magnetic disks and the number of magnetic heads can be increased or decreased as needed, and the size of the magnetic disks can be selected in various ways. The shapes of the first and second heaters are not limited to those of the embodiments described above, and can be changed in various ways as needed.

What is claimed is:

1. A magnetic disk device comprising:
a rotatable magnetic disk; and
a magnetic head including a recording head portion that records data on the magnetic disk,
the recording head portion comprising:
a main magnetic pole that applies a recording magnetic field to the magnetic disk; a first yoke provided on a first side of the main magnetic pole; and a second yoke provided on a second side of the main magnetic pole, which is opposite to the first side,
the magnetic head including a first heater provided to oppose a side of the first yoke, opposite to the main magnetic pole and a second heater provided to oppose a side of the second yoke, opposite from the main magnetic pole.

2. The device of claim 1, wherein
the first side is a trailing side and the second side is a leading side.

3. The device of claim 1, wherein
the first heater and the second heater each include a lower end portion located near a lower surface of the magnetic head.

4. The device of claim 1, wherein
the first heater and the second heater each include an upper end portion located at a same height as that of the recording head portion.

5. The device of claim 1, wherein
the first heater includes an upper end located at a same height as that of the first yoke, and the second heater includes an upper end located at a same height as that of the second yoke.

6. The device of claim 1, further comprising:
a voltage supply portion which supplies power to the first heater and the second heater,
wherein
the first heater and the second heater are connected in parallel to the voltage supply portion.

7. The device of claim 1, further comprising:
a voltage supply portion which supplies power to the first heater and the second heater,
wherein
the first heater and the second heater are connected in series to the voltage supply portion.

8. The device of claim 1, further comprising:
a voltage supply portion which supplies power to the first heater and the second heater,
wherein
the first heater and the second heater are independently connected to the voltage supply unit.

9. The device of claim 1, wherein
the magnetic head comprises a reproduction head portion that reads data recorded on the magnetic disk, and a third heater that heats the reproduction head portion,
the first side is a trailing side, and the second side is a leading side,
the recording head portion is provided on the trailing side, and
the reproduction head portion is provided on the leading side.
